(19) United States
(12) Patent Application Publication
(10) Pub. No.: US 2003/0005795 A1
(43) Pub. Date: Jan. 9, 2003

(54) Ratchet wrench having positioning device

(76) Inventor: Frank McCann, Taichung Hsien (TW)

Correspondence Address: PILLSBURY WINTHROP LLP, INTELLECTUAL PROPERTY GROUP, P. O. BOX 10500, MCLEAN, VA, 22102, US

(21) Appl. No.: 09/898,131

(22) Filed: Jul. 5, 2001

(51) Int. Cl. B25B 13/46

(52) U.S. Cl. 81/63.2

(57) ABSTRACT

A wrench includes a driving head for driving a fastener, and a latch slidably engaged in the driving head and movable inward of the driving head for engaging with the fastener and for preventing the head from moving relative to the fastener. A cover is secured to the head and has a passage for slidably receiving the latch. A catch may be secured to the cover and engaged with the latch for limiting the sliding movement of the latch relative to the cover and for preventing the latch from being disengaged from the cover.

### BACKGROUND OF THE INVENTION

1. Field of the Invention

The present invention relates to a wrench, and more particularly to a ratchet wrench having a positioning device for positioning the ratchet wrench to the fastener to be driven by the ratchet wrench.

2. Description of the Prior Art

Various kinds of typical ratchet wrenches have been developed and used today. U.S. Pat. No. 5,957,009 to the present applicant, McCann, discloses one of the typical ratchet wrenches including a number of elements that may not be easily manufactured and assembled. In addition, the typical wrenches, or the ratchet wrenches may not be attached or positioned to the fasteners and may not be prevented from moving relative to the fastener when the fastener is elevated and is not engaged with the other objects.

The present invention has arisen to mitigate and/or obviate the afore-described disadvantages of the conventional ratchet wrenches.

### SUMMARY OF THE INVENTION

The primary objective of the present invention is to provide a ratchet wrench including a positioning device for positioning the ratchet wrench to the fastener to be driven by the ratchet wrench and for preventing the ratchet wrench from moving relative to the fastener when driving the fastener.

In accordance with one aspect of the invention, there is provided a wrench comprising a driving head including an engaging hole provided therein for receiving and driving a fastener, and latch means for retaining the driving head to the fastener.

The latch means includes a latch slidably engaged in the driving head and movable inward of the engaging hole of the driving head for engaging with the fastener. A cover is further provided and secured to the head and includes a passage formed therein, the latch is slidably received in the passage of the cover.

A device is further provided for positioning the cover to the driving head and includes a spring biasing projection provided in the driving head for engaging with the cover and for positioning the cover to the driving head.

The cover includes at least one cavity formed therein for receiving the spring biasing projection and for positioning the cover to the driving head. The cover includes a knob having a catch attached thereto and having the cavity formed therein for receiving the spring biasing projection.

The latch includes an oblong hole formed therein, the catch includes a protrusion extended therefrom and slidably engaged into the oblong hole of the latch for limiting a sliding movement of the latch relative to the cover. The driving head includes an opening formed therein, a gear rotatably received in the opening of the driving head and having the engaging hole formed therein for receiving the fastener.

The gear includes a barrel extended therefrom and having the engaging hole formed in the barrel, the cover includes a sleeve having an aperture formed therein for receiving the barrel, the aperture of the sleeve is communicated with the passage of the cover.

The driving head includes a chamber formed therein and communicating with the opening of the driving head and having two ends, the wrench further includes a pawl slidably received in the chamber of the driving head and movable between the ends of the chamber of the driving head for engaging with the gear.

The cover includes a knob provided thereon and having an extension extended therefrom for engaging with the pawl and for moving the pawl between the ends of the chamber of the driving head. A spring member is further provided and engaged between the knob and the pawl for biasing the pawl to engage with the gear. The pawl includes a recess formed therein, the spring member is received in the recess of the pawl and engaged between the extension of the knob and the pawl.

The pawl includes a pair of side walls and a front wall extended therefrom for defining the recess thereof, the spring member is received in the recess of the pawl and engaged between the side walls and the front wall of the pawl, and moved in concert with the pawl. The front wall of the pawl includes a notch formed therein and aligned with the extension of the knob, for allowing the spring member to be deformed. The spring member includes a notch formed therein for receiving the extension of the knob.

A ratchet device may further be provided in the driving head for actuating the fastener.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a perspective view of a ratchet wrench in accordance with the present invention;

FIG. 2 is an exploded view of the ratchet wrench;

FIG. 3 is a cross sectional view taken along lines 3-3 of FIG. 1;

FIGS. 4 and 5 are top plane schematic views illustrating the operation of the ratchet wrench; and

FIGS. 6 and 7 are cross sectional views similar to FIG. 3, illustrating the operation of the positioning device of the ratchet wrench.

### DETAILED DESCRIPTION OF THE PREFERRED EMBODIMENT

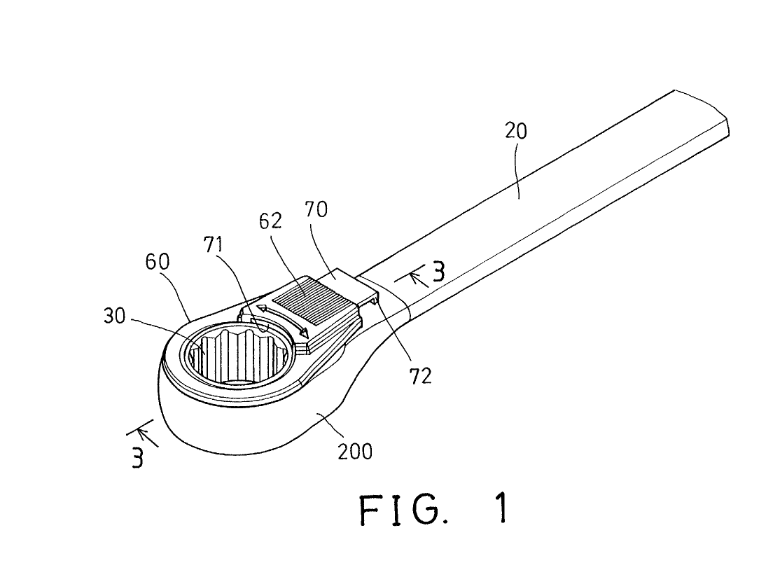

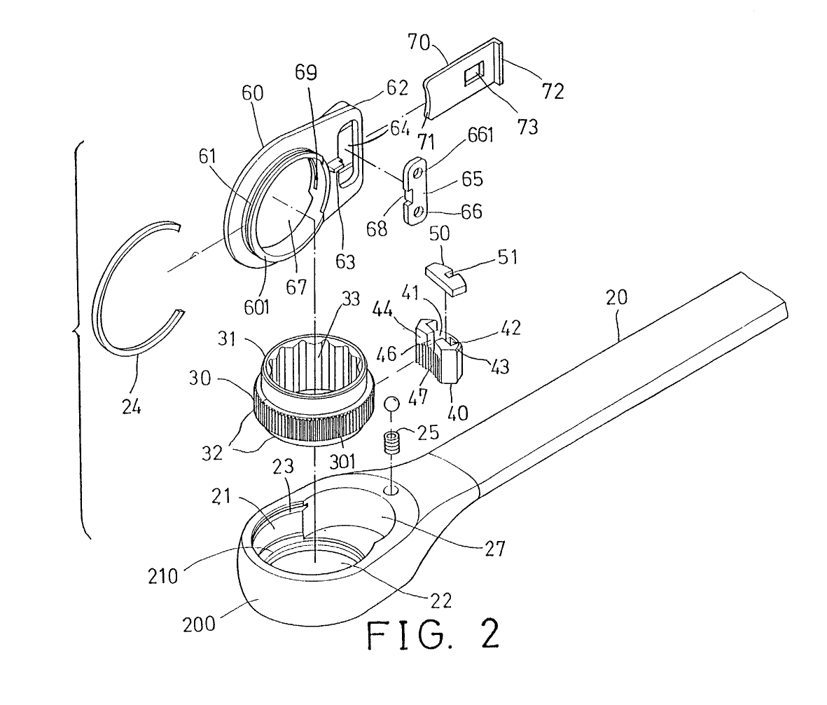

Referring to the drawings, and initially to FIGS. 1-4, a ratchet wrench in accordance with the present invention comprises a handle 20 including a driving head 200 formed and provided on one end thereof and having an opening 21 and a chamber 27 formed therein and intersecting with each or communicating with each other, and having an orifice 22 formed in the bottom portion thereof and communicating with the opening 21 thereof and having an inner diameter smaller than that of the opening 21 of the head 200 for forming or defining an annular or a peripheral flange 210 in the bottom of head 200. A peripheral groove 23 is formed in the upper portion of the head 200 and communicating with the opening 21 of the head 200. A spring-biased projection 25 is provided in the head 200 and particularly provided in the rear portion of the head 200 close to the handle 20.

A gear 30 is rotatably received in the opening 21 of the head 200 and includes a number of teeth 301 formed on the outer peripheral portion thereof and includes a barrel 31 extended upward and downward therefrom and having an outer diameter smaller than that of the gear 30 for defining an upper and a lower peripheral shoulders 32 therein. The lower peripheral shoulder 32 of the gear 30 is rotatably engaged with the peripheral shoulder 210 of the head 200, and the lower portion of the barrel 31 is rotatably received in the orifice 22 of the head 200. The barrel 31 includes an engaging hole 33 formed therein for receiving and for driving the fasteners or the tool bits or the tool extensions or the like therein.

A pawl 40 is slidably received in the chamber 27 of the head 200 and includes one or more teeth 47 formed in the front portion thereof for engaging with the gear 30, and includes a recess 41 formed in the upper portion thereof and defined by two side walls 43 and a front wall 44, and includes a cavity 42 formed in the upper portion thereof and communicating with the recess 41 thereof. The front wall 41 of the pawl 40 includes a notch 46 formed therein and aligned with the cavity 42 of the pawl 40. A spring member 50 is preferably made of resilient materials, such as the rubber materials, and is engaged in the recess 41 of the pawl 40 and includes a notch 51 formed therein and aligned with the cavity 42 of the pawl 40. The spring member 50 is engaged with the side walls 43 and the front wall 44 such that the spring member 50 may be moved by the pawl 40 or may be moved in concert with the pawl 40.

A cover 60 includes an aperture 67 formed therein and formed or defined by a sleeve 601. The sleeve 601 is extended inward of the opening 21 of the head 200 and is engaged with the upper peripheral shoulder 32 of the gear 30 for rotatably retaining the gear 30 in the head 200, and includes a peripheral channel 61 formed in the outer peripheral portion thereof for receiving a clamping or retaining ring 24 which may also engage in the peripheral groove 23 of the head 200 for securing the cover 60 to the head 200 and for rotatably retaining and securing the gear 30 within the head 200. The cover 60 includes a knob 62 having an extension 63 extended downward therefrom and engaged in the notch 51 of the spring member 50 and loosely received in the cavity 42 of the pawl 40, and aligned with the notch 46 of the pawl 40. The knob 62 of the cover 60 includes a depression 64 formed in the rear and bottom portion thereof. A passage 69 is formed in the knob 62 of the cover 60 and communicating with the aperture 67 and the depression 64 of the knob 62.

A catch 65 is received in the depression 64 of the cover 60 and secured in the cover 60 with such as a force-fitted engagement or with adhesive materials, or by the welding processes. The catch 65 may further include a protrusion 68 extended therefrom for engaging into the passage 69 of the cover 60. The catch 65 includes two cavities 66, 661 formed in the bottom portion thereof for receiving the spring-biased projection 25 and for positioning the cover 60 to the head 200 and the required angular position. A latch 70 is slidably engaged in the passage 69 of the cover 60 and includes an engaging end 71 provided on one end thereof for engaging into the aperture 67 of the knob 62 and for engaging with the fasteners 80, and includes a channel or an oblong hole 73 formed therein for slidably receiving the protrusion 68 of the catch 65 and for limiting the sliding movement of the latch 70 relative to the cover 60 and the head 200. The latch 70 includes a hand grip 72 extended therefrom for facilitating the movement of the latch 70 relative to the cover 60.

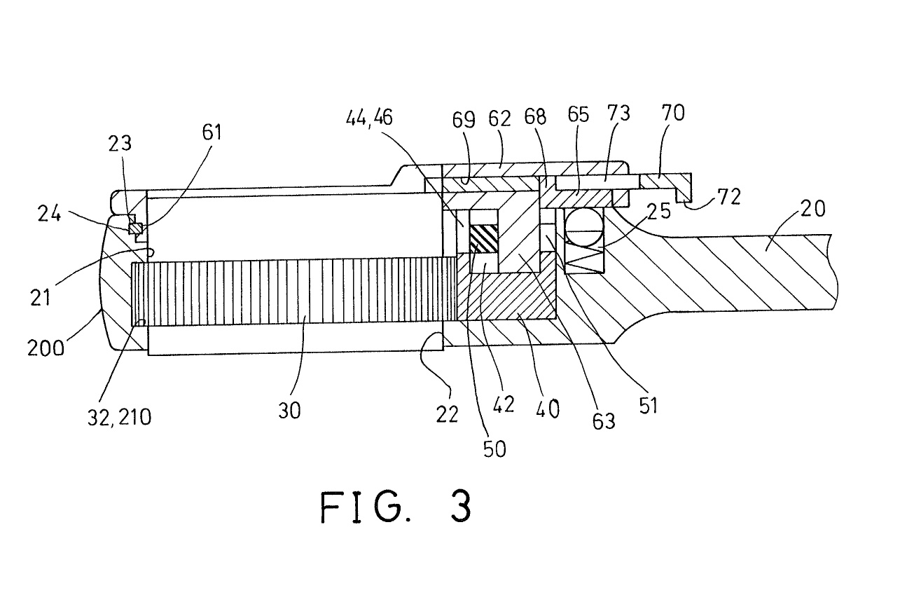

As best shown in FIGS. 3-5? the spring member 50 is engaged between the extension 63 of the cover 60 and the front wall 44 of the pawl 40, and thus may apply a force against the pawl 40 to force the teeth 47 of the pawl 40 to engage with the gear 30. The cavity 42 of the pawl 40 includes a width or a length greater than that of the extension 63 of the cover 60 such that the extension 63 of the cover 60 may be loosely received in the cavity 42 of the pawl 40 and may force the spring member 50 against the pawl 40. When the pawl 40 is moved or rotated relative to the gear 30 or the head 200, the spring member 50 allows the pawl 40 to be moved over the teeth 301 of the gear 30 such that the pawl 40 may be moved to either of the ends of the chamber 27 of the head 200.

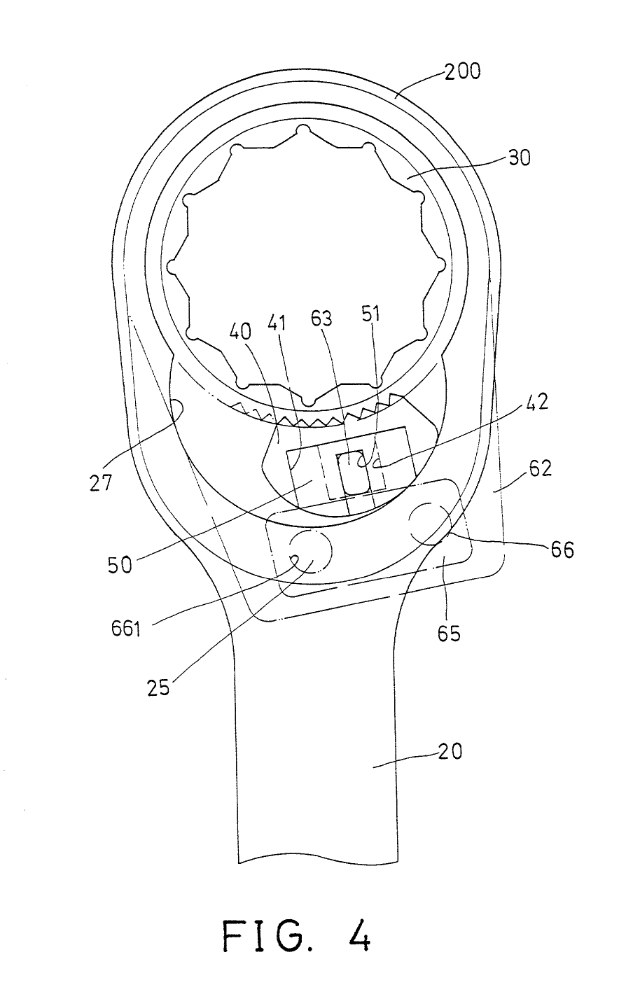

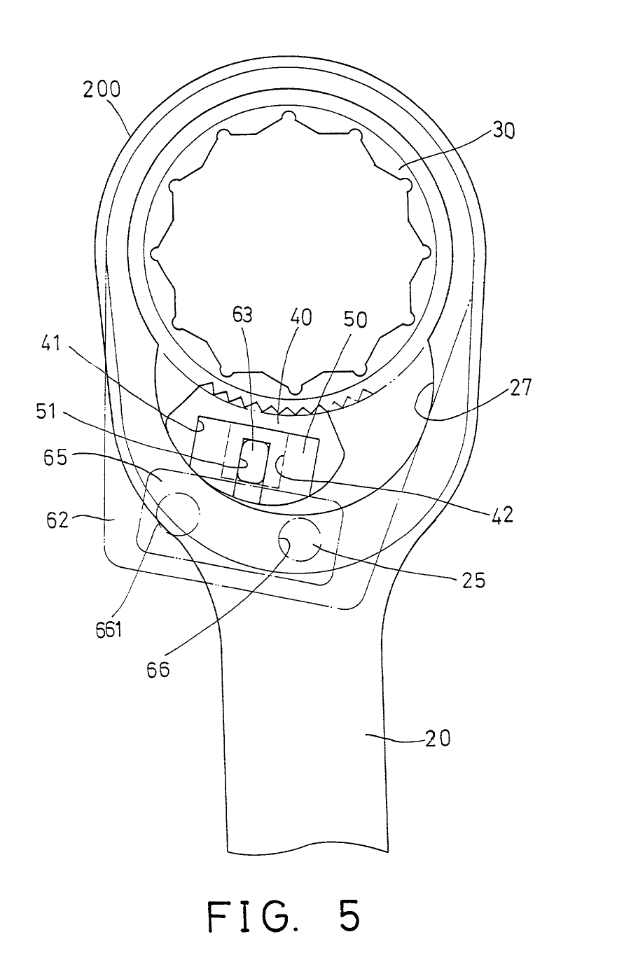

In operation, as shown in FIGS. 3-5, the pawl 40 may be moved to either of the ends of the chamber 27 of the head 200 in order to control the rotational movement of the gear 30 relative to the head 200. As shown in FIG. 4, when the pawl 40 is moved to the right end of the chamber 27 of the head 200 by the knob 62 of the cover 60, the gear 30 may be rotated clockwise by the handle 20 and the head 200 and may not be rotated by the handle 20 when the handle 20 and the head 200 are rotated counterclockwise relative to the gear 30. As shown in FIG. 5, when the pawl 40 is moved to the left end of the chamber 27 of the head 200 by the knob 62 of the cover 60, the gear 30 may be rotated counterclockwise by the handle 20 and the head 200 and may not be rotated by the handle 20 when the handle 20 and the head 200 are rotated clockwise relative to the gear 30.

It is to be noted that the extension 63 of the cover 60 may be easily engaged through the notch 51 of the spring member 50 and the cavity 42 of the pawl 40 when the cover 60 is engaged onto and secured to the head 200, such that the ratchet wrench includes fewer elements or members or parts that may be easily manufactured and assembled. The rubber spring member 50 may be replaced by the other spring materials and engaged between the pawl 40 and the extension 63 of the cover 60 for biasing the pawl 40 to engage with the gear 30. The provision of the notch 46 in the front wall 44 of the pawl 40 allows the spring member 50 to be slightly deformed, or may be used for increasing the spring force or the deformation of the spring member 50.

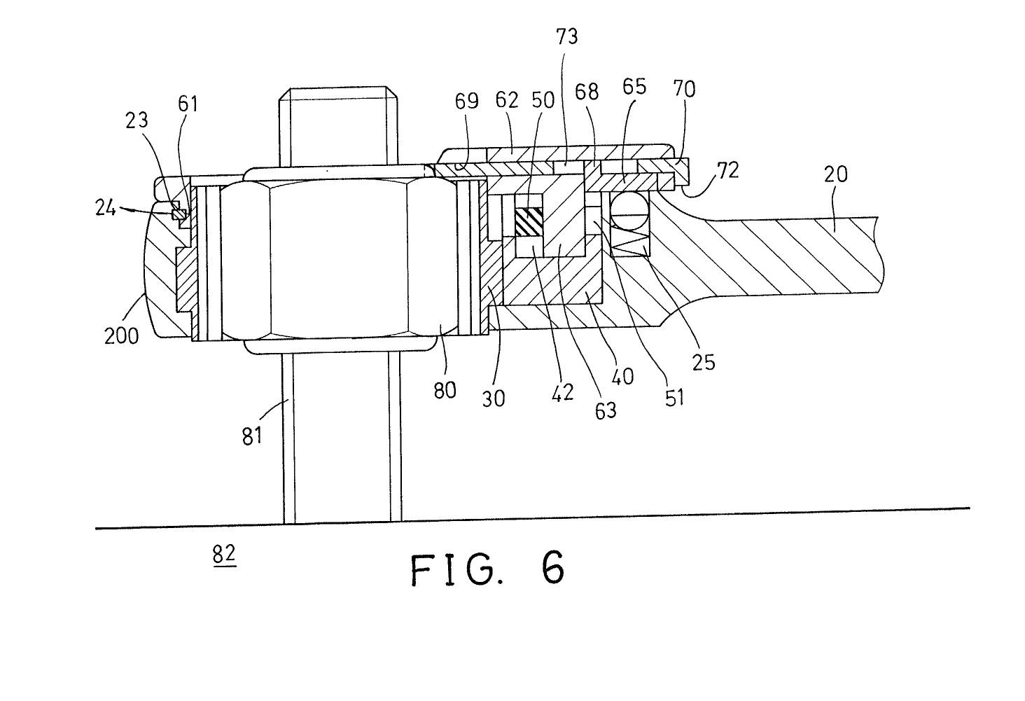

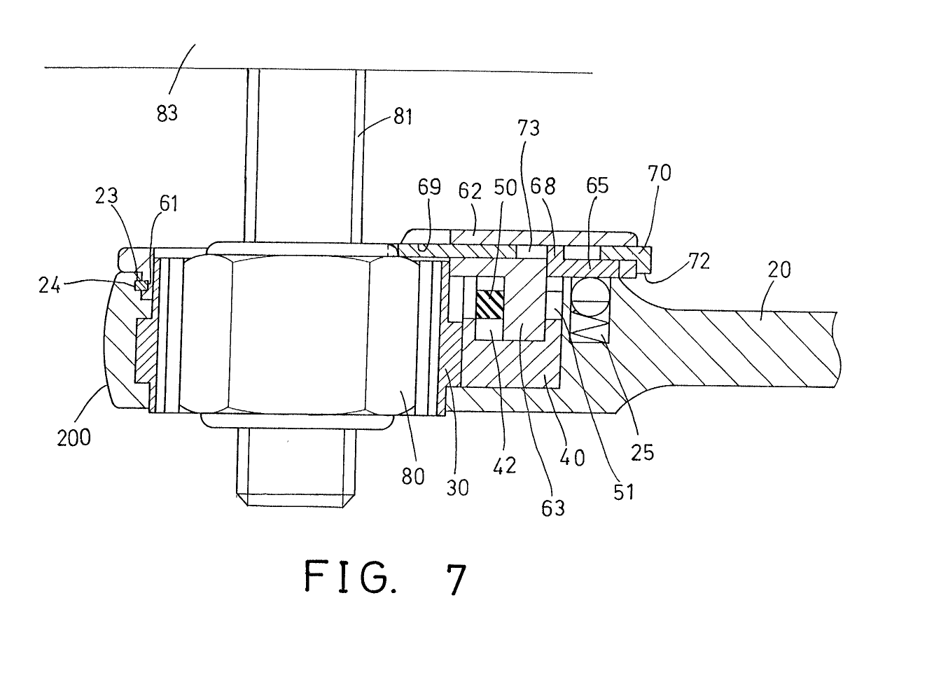

As shown in FIGS. 1 and 6, 7, the latch 70 may be moved relative to the cover 60 or the head 200 and may be engaged onto the fastener 80. For example, as shown in FIGS. 6 and 7, the fastener 80 is threaded to a bolt 81 and is elevated and is not engaged with the supporting surface 82 (FIG. 6) or the supporting object 83 (FIG. 7). The engaging end 71 of the latch 70 may be engaged onto the fastener 80 for positioning the head 200 to the fastener 80 and for preventing the head 200 from moving downward relative to the fastener 80 due to the gravity of the head 200. The fastener 80 may thus be easily and effectively driven by the head 200.

Accordingly, the ratchet wrench in accordance with the present invention includes a positioning device for positioning the ratchet wrench to the fastener to be driven by the ratchet wrench and for preventing the ratchet wrench from moving relative to the fastener when driving the fastener.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A wrench comprising:
a driving head including an engaging hole provided therein for receiving and driving a fastener, and
latch means for retaining said driving head to the fastener.

2. A wrench according to claim 1, wherein said latch means includes a latch slidably engaged in said driving head and movable inward of said engaging hole of said driving head for engaging with the fastener.

3. The wrench according to claim 2 further comprising a cover secured to said head and including a passage formed therein, said latch being slidably received in said passage of said cover.

4. The wrench according to claim 3 further comprising means for positioning said cover to said driving head.

5. The wrench according to claim 4, wherein said positioning means includes a spring biasing projection provided in said driving head for engaging with said cover and for positioning said cover to said driving head.

6. The wrench according to claim 5, wherein said cover includes at least one cavity formed therein for receiving said spring biasing projection and for positioning said cover to said driving head.

7. The wrench according to claim 6, wherein said cover includes a knob having a catch attached thereto and having said at least one cavity formed therein for receiving said spring biasing projection.

8. A wrench according to claim 7, wherein said latch includes an oblong hole formed therein, said catch includes a protrusion extended therefrom and slidably engaged into said oblong hole of said latch for limiting a sliding movement of said latch relative to said cover.

9. A wrench according to claim 3, wherein said driving head includes an opening formed therein, a gear rotatably received in said opening of said driving head and having said engaging hole formed therein for receiving the fastener.

10. The wrench according to claim 9, wherein said gear includes a barrel extended therefrom and having said engaging hole formed in said barrel, said cover includes a sleeve having an aperture formed therein for receiving said barrel, said aperture of said sleeve is communicated with said passage of said cover.

11. The wrench according to claim 9, wherein said driving head includes a chamber formed therein and communicating with said opening of said driving head and having two ends, said wrench further includes a pawl slidably received in said chamber of said driving head and movable between said ends of said chamber of said driving head for engaging with said gear.

12. The wrench according to claim 11, wherein said cover includes a knob provided thereon and having an extension extended therefrom for engaging with said pawl and for moving said pawl between said ends of said chamber of said driving head.

13. The wrench according to claim 12 further comprising a spring member engaged between said knob and said pawl for biasing said pawl to engage with said gear.

14. The wrench according to claim 13, wherein said pawl includes a recess formed therein, said spring member is received in said recess of said pawl and engaged between said extension of said knob and said pawl.

15. The wrench according to claim 14, wherein said pawl includes a pair of side walls and a front wall extended therefrom for defining said recess thereof, said spring member is received in said recess of said pawl and engaged between said side walls and said front wall of said pawl, and moved in concert with said pawl.

16. The wrench according to claim 15, wherein said front wall of said pawl includes a notch formed therein and aligned with said extension of said knob, for allowing said spring member to be deformed.

17. The wrench according to claim 13, wherein said spring member includes a notch formed therein for receiving said extension of said knob.

18. The wrench according to claim 1 further comprising ratchet means provided in said driving head for actuating the fastener.

19. The wrench according to claim 1 further comprising means for positioning said cover to said driving head, said positioning means includes a spring biasing projection provided in said driving head, said cover including a catch attached thereto and having two cavities formed therein for selectively receiving said spring biasing projection and for selectively positioning said cover to said driving head.
